(19) United States
(12) Patent Application Publication
(10) Pub. No.: US 2017/0001659 A1
(43) Pub. Date: Jan. 5, 2017

(54) ELECTRIC POWER STEERING CONTROL DEVICE

(71) Applicant: MAZDA MOTOR CORPORATION, Hiroshima (JP)

(72) Inventor: Masaki CHIBA, Hiroshima-city (JP)

(73) Assignee: MAZDA MOTOR CORPORATION, Hiroshima (JP)

(21) Appl. No.: 15/180,241

(22) Filed: Jun. 13, 2016

(30) Foreign Application Priority Data
Jul. 3, 2015 (JP) 2015-134128

(51) Int. Cl. B62D 5/04; B62D 6/10

(52) U.S. Cl. CPC B62D 5/0472; B62D 5/0463; B62D 5/0409; B62D 6/10

(57) ABSTRACT

There is provided a correcting mechanism (a vibration suppression torque generator, an adder) to correct a motor torque set by an assist map by using a vibration-suppression gain outputted by a filter processor so as to suppress the shimmy. The above-described filter processor includes a vibration extracting filter which has a frequency characteristic that a gain becomes a peak (maximum magnitude) at a cut-off angle frequency and a phase advances by 90° at the cut-off angle frequency and a gain adjustor to vary the cut-off angle frequency of the vibration extracting filter in accordance with a tire rotation frequency which is changeable according to a vehicle speed.

### BACKGROUND OF THE INVENTION

The present invention relates to a control device of an electric power steering which is installed in a vehicle, such as an automotive vehicle, and specifically relates to an electric power steering control device capable of suppressing a vibration due to a rotation of a tire, such as a shimmy vibration.

The electric power steering installed in the vehicle, such as the automotive vehicle, comprises a motor to apply an assist torque to a steering device, a torque sensor to detect a steering torque applied by a driver, a vehicle speed sensor to detect a vehicle speed, and a control unit (ECU). The ECU sets a torque to be outputted by the motor (a motor torque) based on the steering torque detected by the torque sensor and the vehicle speed detected by the vehicle speed, and controls a current to be applied to the motor so as to provide the set motor torque (which is called an assist control).

Conventionally, the ECU simultaneously performs a vibration suppression control to suppress a vibration due to disturbance, such as sympathetic vibrations, in addition to the above-described assist control. The reason for this is that if the vibration suppression control is not performed, the above-described vibration is not only transmitted to driver's hands but a torque due to the above-described vibration is increased by the assist control.

U.S. Pat. No. 8,626,394 B2 discloses, as an example of the vibration suppression control, a device which comprises an assist map to output an assist torque current (a current to be applied to a motor) based on a steering torque applied by a driver, a vibration extracting filter to output a vibration component signal by decreasing a low-frequency side gain through performing filter processing on a rotational speed of the motor, a current variable gain map to calculate a current variable gain based on the current flowing through the motor, and a rotational-speed variable gain map to calculate a rotational-speed variable gain based on the rotational speed of the motor, thereby calculating a vibration suppression current based on the vibration component signal, the current variable gain and the rotational speed variable gain, and then correcting the assist torque current by using the calculated vibration suppression current.

Meanwhile, there occurs a shimmy vibration (tire shimmy) as one of vibrations experienced often during driving of the vehicle. The shimmy is the one due to an improper wheel balance and caused by a tire exchange, correction of the wheel balance, or the like. For example, when a vehicle travels at about 100-120 km/h (with a tire rotation frequency of about 10 Hz) on a highway, a steering wheel may vibrate slightly and quickly, which is the shimmy.

A vibration occurs inside a suspension device supported at a front sub frame due to the rotation of the tire, and this occurring vibration (the vibration due to the tire rotation) is transmitted to a steering wheel through a steering device including a tie rod, a pinion-rack mechanism, a steering shaft, and so on. The shimmy occurs accordingly. The suspension device comprises many kinds of members, and each member has a natural frequency which is unique and different. Some of the above-described many kinds of members resonate with the rotation frequency of the tire and plural resonations of these members are combined and transmitted together, thereby generating the shimmy Therefore, there are plural members resonating when the shimmy occurs, and thus it is not easy to find out the member which causes the shimmy.

Herein, since the shimmy occurs when the rotation frequency of the tire increases to a specified frequency and the vibrations of the plural members of the suspension device which resonate at this specified frequency are combined and transmitted to the driver's hands through the steering device, it is clear that the shimmy occurs when the vehicle speed increases up to a specified speed. Further, the rotation frequency of the tire where the shimmy occurs (a shimmy occurrence frequency: 10 Hz in the above-described example) depends on vehicles which have individuality, different repair history, and the like, or aged deterioration of the suspension device, for example, of a vehicle itself. That is, the vehicle speed which causes the shimmy is unpredictable, so that it is necessary to have investigated this vehicle speed in advance.

The vibrations which occur due to the rotation of the tire described above include the one which is caused by deformation of a disc plate of a disc brake except the shimmy.

### SUMMARY OF THE INVENTION

An object of the present invention is to provide an electric power steering control device which can properly suppress the vibration due to the tire rotation, such as the shimmy.

The present invention is an electric power steering control device which comprises a motor to apply an assist torque to a steering device, a torque detector to detect a steering torque applied by a driver, a setting mechanism to set a motor torque to be outputted to the motor based on the steering torque detected by the torque detector, a rotational angle detector to detect a rotational angle of the motor, a filter processor to output a vibration-suppression gain for suppressing a vibration due to a tire rotation by performing a filter processing on the rotational angle detected by the rotational angle detector, and a correcting mechanism to correct the motor torque set by the setting mechanism by using the vibration-suppression gain outputted by the filter processor so as to suppress the vibration due to the tire rotation, wherein the filter processor is configured to include a vibration extracting filter which has a frequency characteristic that a gain becomes a specified magnitude (value) at a cut-off angle frequency and a phase advances by 90° at the cut-off angle frequency and to vary the cut-off angle frequency of the vibration extracting filter in accordance with a tire rotation frequency which is changeable according to a vehicle speed.

According to the present invention, since the cut-off angle frequency of the vibration extracting filter is varied in accordance with the tire rotation frequency which is changeable according to the vehicle speed, even if the vibration due to the tire rotation (e.g., the shimmy) has occurred at any frequency, this vibration is always suppressed by correcting based on the vibration-suppression gain. Accordingly, even if the frequency of the vibration due to the tire rotation is changeable according to the vehicle's individuality, the aged deterioration of the suspension device, or the like, the vibration due to the tire rotation is always suppressed properly. Further, since it is unnecessary to previously know the frequency of the vibration due to the tire rotation, suppressing of the vibration due to the tire rotation can be achieved easily. Moreover, since the phase of the vibration-suppression gain is 90° advanced, correcting of the motor torque by means of the correcting mechanism is performed with a 90° shifted phase. Consequently, a viscosity is applied (a viscosity application control), so that the vibration due to the tire rotation is suppressed by the viscosity surely and effectively.

Herein, it is preferable in the present invention that the above-described cut-off angle frequency be varied such that the cut-off angle frequency becomes higher according to an increase of the vehicle speed and the cut-off angle frequency becomes lower according to a decrease of the vehicle speed.

Further, it is preferable that the above-described cut-off angle frequency be varied stepwise at predetermined intervals.

In an embodiment of the present invention, the filter processor includes a gain adjuster to adjust the vibration-suppression gain such that the vibration-suppression gain is zero in a range which is lower than a specified lower-limit frequency which is lower than the cut-off angle frequency and higher than a frequency of a driver's steering component but the vibration-suppression gain becomes greater as the frequency is higher in another range which is higher that the specified lower-limit frequency.

According to this embodiment, since the motor torque set by the setting mechanism is not corrected in the range where a vibration level is low, the assist control for assisting the driver's steering is properly performed, without being influenced by the vibration suppression control. Meanwhile, since the motor torque set by the setting mechanism is corrected more greatly when the vibration level is higher, the vibration suppression control is performed properly.

Other features, aspects, and advantages of the present invention will become apparent from the following description which refers to the accompanying drawings.

### BRIEF DESCRIPTION OF THE DRAWINGS

FIG. 1 is an entire structure of an electric power steering according to an embodiment of the present invention.

FIG. 2 is a block diagram of the electric power steering.

FIG. 3 is a graph showing an assist map in the above-described block diagram.

FIG. 4 is a bode diagram showing a frequency characteristic of a vibration extracting filter in the above-described block diagram.

FIG. 5 is a graph showing a relation between a tire rotation frequency and an acceleration of a steering wheel in a circumferential direction, which is for explaining an occurrence of a tire shimmy.

FIG. 6 is an image graph of a case in which a gain adjuster shown in the above-described block diagram varies a cut-off angle frequency of the vibration extracting filter of FIG. 4 in accordance with the tire rotation frequency which is changeable according to a vehicle speed.

FIG. 7 is a graph showing a performance of the gain adjuster.

FIG. 8 is a graph showing occurrence states of the shimmy before or after improvement in first and second experimental examples, respectively, which is for explaining an effect of the embodiment.

### DETAILED DESCRIPTION OF THE INVENTION

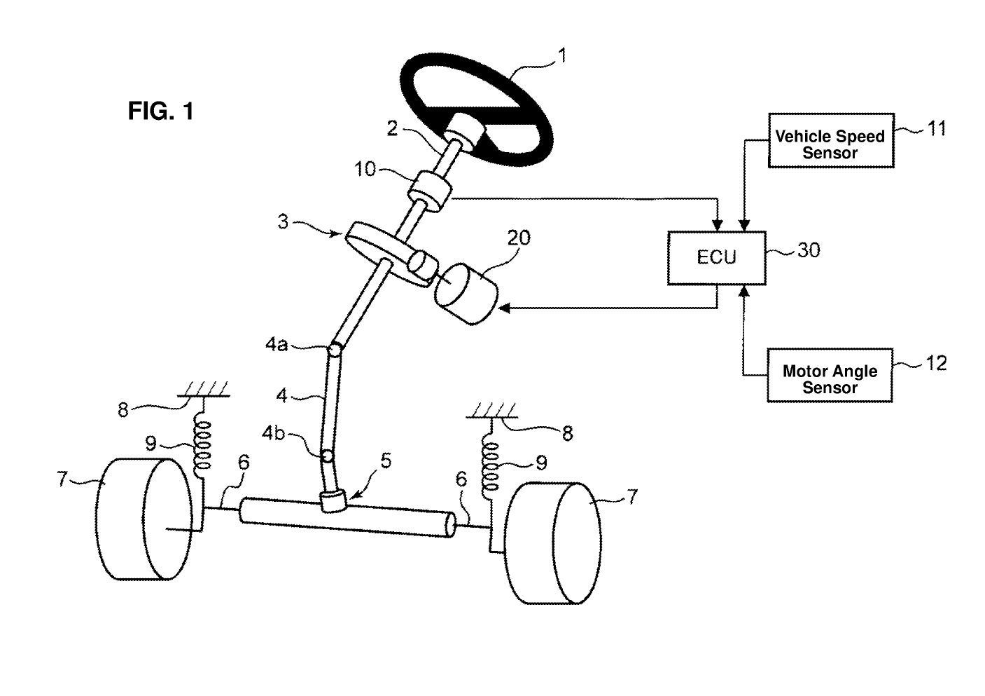

As shown in FIG. 1, a vehicle (not illustrated) according to the present embodiment comprises a steering wheel 1, a steering shaft 2, an intermediate shaft 4 coupled via universal joints 4a, 4b provided at its both ends, a pinion rack mechanism 5, and a steering device to steer front wheels 7 through tie rods 6. Further, in this vehicle is installed a column assist type of electric power steering for applying an assist torque to the steering device, which comprises a motor 20 which is coupled to the steering shaft 2 via a speed reduction gear 3, a torque sensor (corresponding to a “torque detector” of the present invention) 10 to detect a steering torque applied by a driver, a vehicle speed sensor 11 to detect a vehicle speed, and an ECU (Electric Control Unit) 30.

In FIG. 1, reference character 8 denotes a front sub frame which is a frame located at a lowermost position of a front portion of the vehicle and on which an engine (not illustrated) is mounted, and reference character 9 denotes a suspension device of the front wheels 7 which is supported at the front sub frame 8.

The ECU 30 is a microprocessor comprising CPU, ROM, RAM and others, and configured to set a motor torque to be outputted to the motor 20 based on the steering torque detected by the torque sensor 10 and the vehicle speed detected by the vehicle speed sensor 11 and control a current to be applied to the motor so as to provide the set motor torque (an assist control).

The electric power steering simultaneously performs a vibration suppression control to suppress a vibration due to a tire rotation, such as a vibration which is caused by shimmy or deformation of a disc plate of a disc brake. For this performance, it comprises a motor angle sensor (corresponding to a “rotational angle detector” of the present invention) 12 to detect a rotational angle of the motor 20.

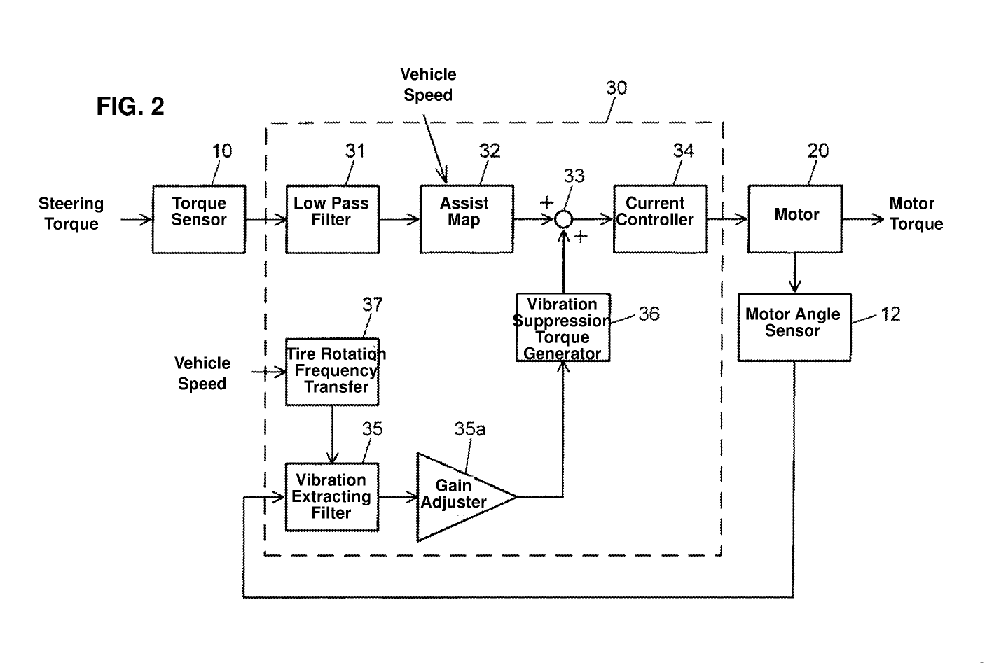

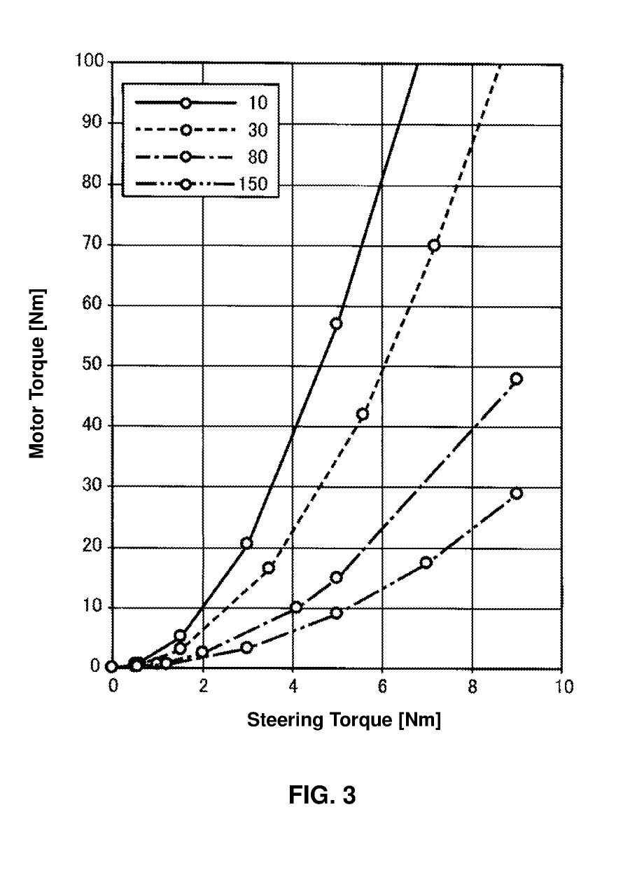

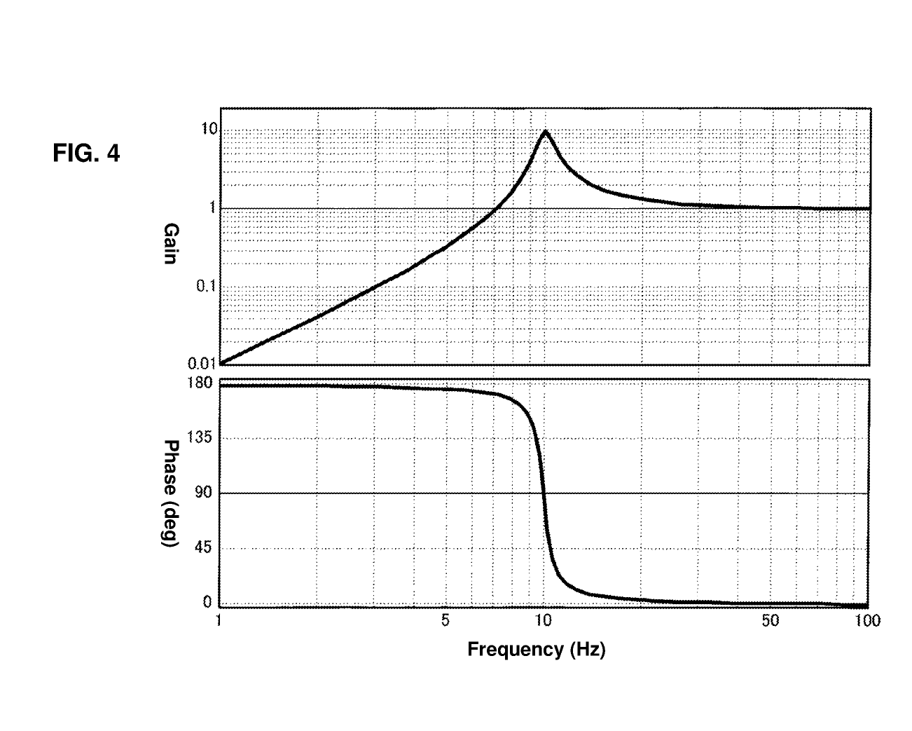

Hereafter, the above-described vibration suppression control according to the present embodiment will be described. FIG. 2 is a block diagram of the electric power steering, FIG. 3 is a graph showing an assist map in the above-described block diagram, and FIG. 4 is a bode diagram showing a frequency characteristic of a vibration extracting filter in the above-described block diagram.

As shown in FIG. 2, the steering torque applied by the driver is detected by the torque sensor 10 and inputted to a low pass filter 31. A steering component signal on a low-frequency side, including a frequency of a driver's steering component (about 4-6 Hz), is extracted from the torque inputted to the low pass filter 31 and inputted to an assist map (corresponding to a “setting mechanism” of the present invention) 32. The assist map 32 shows input-output characteristics between the steering torque as an input and the motor torque as an output as shown in FIG. 3. The input-output characteristics are set in advance. Specifically, the abscissa of the graph represents the steering torque and the ordinate represents the motor torque. In an example of this graph, the respective input-output characteristics of the vehicle speeds of 10 km/h, 30 km/h, 80 km/h, and 150 km/h are set. The vehicle speed detected by the vehicle speed sensor 11 is inputted to the assist map 32. Herein, the greater the steering torque is or the lower the vehicle speed is, the greater the set motor torque is.

The motor torque set by the assist map 32 is corrected by an adder (corresponding to part of a “correcting mechanism” of the present invention) 33. Specifically, the motor torque set by the assist map 32 is inputted to the adder 33, where a vibration suppression torque which is generated at a vibration suppression torque generator (corresponding to part of the “correcting mechanism” of the present invention) 36, which will be described later, is added. The motor torque corrected by means of the vibration suppression torque generator 36 and the adder 33 is inputted to a current controller 34. The current controller 34 applies a current (a current of electricity) for providing this inputted motor torque to the motor 20. Thereby, the motor torque is increased (amplified) by the speed reduction gear 3 and then applied to the steering shaft 2. Thus, the assist control is performed.

The vibration suppression control which is performed simultaneously with the assist control starts with detecting the rotational angle of the motor 20 by means of the motor angle sensor 12 and inputting this detected rotational angle to the vibration extracting filter 35. The vibration extracting filter 35 is constituted by a well-known secondary bypass filter, which has the following frequency characteristics.

As shown in FIG. 4, the vibration extracting filter 35 extracts the input of a frequency band (7-30 Hz), including a cut-off angle frequency (10 Hz in the illustrated example), on a high-frequency side which is higher than the frequency of the driver's steering component (4-6 Hz), and then outputs by multiplying a first gain having a magnitude larger than 1 and advancing a phase. In particular, at the cut-off angle frequency (10 Hz), the magnitude of the gain becomes a peak (10 in the illustrated example), so the first gain having the magnitude of 10 is outputted with the phase being 90° advanced. 100341 The vibration extracting filter 35 extracts the input of the frequency band (30-100 Hz in the illustrated example) on the high-frequency side which is higher than the above-described frequency band (7-30 Hz), and then outputs by multiplying a second gain having the magnitude of about 1 and substantially not advancing the phase.

The vibration extracting filter 35 extracts the input of the frequency band (1-7 Hz in the illustrated example) on a low-frequency side which is lower than the above-described frequency band (7-30 Hz), and then outputs by multiplying a third gain having the magnitude smaller than 1 and advancing the phase.

The frequency characteristics of the vibration extracting filter 35 can be approximately created (realized) by the following formula (a transfer-function formula of a secondary bypass filter).

s2/(s2+2ζωcs+ωc2) Formula

Herein, s is a Laplace operator, ζ is a damping coefficient, and ωc is the cut-off angle frequency.

The above-described frequency bands (1-7 Hz, 7-30 Hz, 30-100 Hz) can be easily set in various ranges by changing the above-described frequency characteristics of the vibration extracting filter 35 of the secondary bypass filter with the above-described transfer-function formula. For example, any magnitude can be assigned as the cut-off angle frequency ωc which is one of parameters.

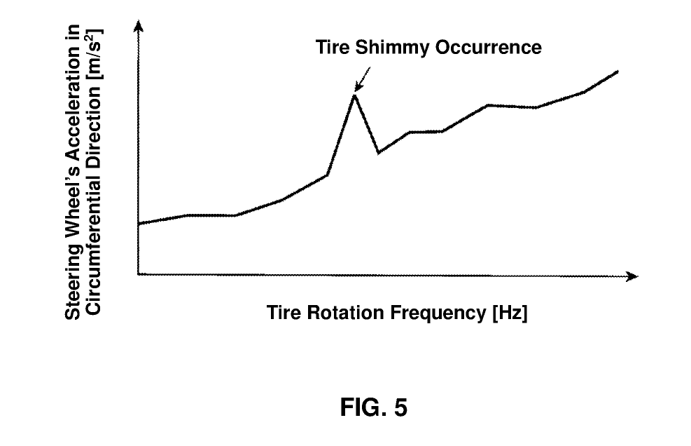

FIG. 5 is a graph showing a relation between a tire rotation frequency which corresponds to the vehicle speed and an acceleration of the steering wheel 1 in a circumferential direction which corresponds to a degree of vibration (vibration level), which is for explaining an occurrence of the shimmy (tire shimmy) The tire rotation frequency f (Hz) is determined from the vehicle speed V (km/h) and a tire radius (dynamic radius) R (m) by using the following conversion formula. For example, when V=110 and R=0.485, f=10.

f=V/(3.6×2×π×R) Conversion Formula

In the present embodiment, a tire rotation frequency convertor which is denoted by reference character 37 in FIG. 2 calculates the tire rotation frequency f based on the vehicle speed detected by the vehicle speed sensor 11 and then outputs to the vibration extracting filter 35.

The shimmy is the vibration due to inferiority of the wheel balance and provides a phenomenon in which the vibration due to the rotation of the tire causes the steering device or its surrounding members to resonate, so that the steering wheel 1 shakes (vibrates) slightly and quickly, for example. That is, a vibration force generated by the rotation of the tire causes a vibration which is generated inside the suspension device 9 supported at the sub frame 8 and this vibration is transmitted to the steering wheel 1 by way of the steering device which comprises the tie rod 6, the pinion rack mechanism 5, the intermediate shaft 4, and the steering shaft 2, and others. This is the shimmy. The shimmy occurs when the tire rotation frequency increases up to a shimmy occurrence frequency (corresponding to a tire rotation frequency when the shimmy occurs) which is a resonance point. Herein, the shimmy occurrence frequency depends on vehicles which have individuality, different repair history, and the like. Also, the shimmy occurrence frequency depends on aged deterioration of the suspension device 9, for example, of a vehicle itself.

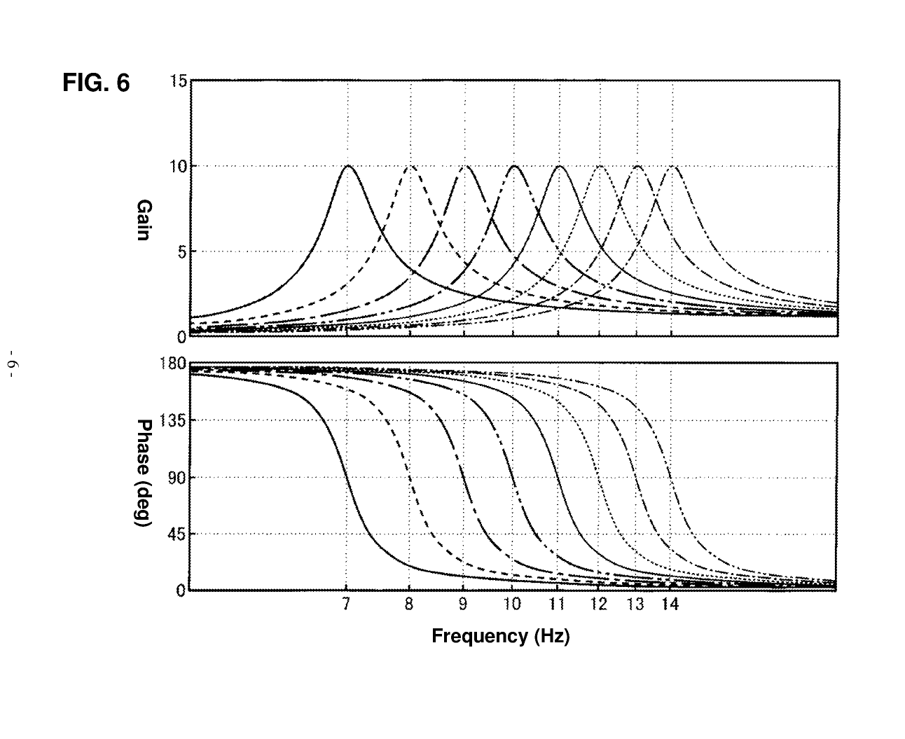

FIG. 6 is an image graph of a case in which the gain adjuster 35a (see FIG. 2) varies the cut-off angle frequency ωc of the vibration extracting filter 35 of FIG. 4 in accordance with the tire rotation frequency which is changeable according to the vehicle speed. That is, the cut-off angle frequency (10 Hz) of the vibration extracting filter 35 shown in FIG. 4 is variably set at the plural tire rotation frequencies (7, 8, 9, 10, 11, 12, 13 and 14 Hz). In other words, the cut-off angle frequency ωc of the vibration extracting filter 35 is changeably adjusted at the different tire rotation frequency. Herein, in FIG. 6, the ordinate of the gain diagram does not provide a logarithmic display (the frequency characteristics of FIG. 6 is the same as that of FIG. 4), which is different from FIG. 4. Herein, the vibration extracting filter 35 and the gain adjuster 35a correspond to a “filter processor” of the present invention.

Specifically, while the cut-off angle frequency of the vibration extracting filter 35 is set at 10 Hz in FIG. 4, that is set at 7, 8, 9, 10, 11, 12, 13 and 14 Hz in FIG. 6. The tire rotation frequency convertor 37 converts a current vehicle speed V (km/h) to the tire rotation frequency f (Hz) according to the above-described conversion formula, and the gain adjuster 35a assigns the obtained magnitude (the current tire rotation frequency) as the cut-off angle frequency ωc of the above-described conversion formula. Thereby, the shimmy which occurs at the current vehicle speed is suppressed by the vibration suppression torque based on the vibration-suppression gain (see the gain diagram of FIG. 6). In this case, it does not matter whether or not the shimmy actually occurs at the current vehicle speed. That is, by setting the tire rotation frequency f (Hz) corresponding to the current vehicle speed V (km/h) as the cut-off angle frequency ωc, it becomes unnecessary that the shimmy occurrence frequency has been investigated in advance, and if the shimmy occurs, the occurring shimmy can be always suppressed. Accordingly, even if the vehicles have different shimmy occurrence frequencies depending on their individualities, repair histories, and the like, or the vehicle itself experiences aged deterioration of the suspension device 9, for example, the shimmy can be properly suppressed. That is, it is unnecessary to know the unpredictable shimmy occurrence frequency or to conduct an investigation to know in advance, and the suppression of the shimmy becomes possible always in such situations.

Returning to FIG. 2, the product of an extraction result of the vibration extracting filter 35 and the gain is inputted to the vibration suppression torque generator 36 by way of the gain adjuster 35a as the vibration-suppression gain.

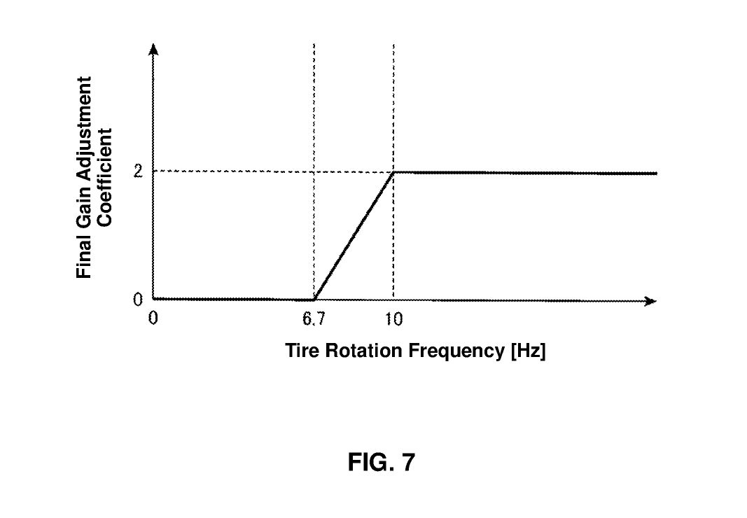

FIG. 7 is a graph showing a performance of the gain adjuster 35a. That is, the gain adjuster 35a reads out a final gain adjustment coefficient, and further multiplies the read-out coefficient by the product of the extraction result of the vibration extracting filter 35 and the gain adjusted by the gain adjuster 35a, i.e., the vibration-suppression gain.

In the illustrated example, since the final gain adjustment coefficient is zero in a range of the tire rotation frequency being 0 Hz or greater and lower than 6.7 Hz (corresponding to a “lower-limit frequency” of the present invention), the vibration-suppression gain having the magnitude of zero is inputted to the vibration suppression torque generator 36 from the gain adjuster 35a. Further, since the final gain adjustment coefficient is 2 in a range of the tire rotation frequency being 10 Hz or greater, the vibration-suppression gain having the relatively large magnitude is inputted to the vibration suppression torque generator 36 from the gain adjuster 35a. Moreover, since the final gain adjustment coefficient becomes greater as the tire rotation frequency is higher in a range of the tire rotation frequency being 6.7 Hz or higher and lower than 10 Hz, the vibration-suppression gain having the magnitude which becomes greater as the tire rotation frequency is higher is inputted.

The vibration suppression torque generator 36 generates the vibration suppression torque based on the inputted vibration-suppression gain. Specifically, the vibration suppression torque is generated such that the greater the vibration-suppression gain is, the larger the magnitude of the vibration suppression torque is. In particular, when the vibration-suppression gain is zero, the vibration suppression torque becomes zero. Further, the vibration suppression torque becomes a peak at the cut-off angle frequency in which the vibration-suppression gain becomes a peak (a maximum magnitude).

The vibration suppression torque generated by the vibration suppression torque generator 36 is inputted to the above-described adder 33, where the vibration suppression torque by the vibration suppression torque generator 36 is added to the motor torque set by the assist map 32 (that is, which is used for correcting the motor torque). In other words, the adder 33 corrects the motor torque set by the assist map 32 by using the vibration suppression torque which is generated by the vibration suppression torque generator 36 based on the vibration-suppression gain outputted through the vibration extracting filter 35 and the gain adjuster 35a so as to suppress the vibration due to the tire rotation, i.e., the shimmy.

Specifically, the smaller the vibration-suppression gain is, the smaller the vibration suppression torque generated by the vibration suppression torque generator 36 is, and therefore the correction of the motor torque is slight. In particular, when the vibration-suppression gain is zero, the vibration suppression torque becomes zero, and therefore the motor torque is not corrected at all. Consequently, the assist control for assisting the driver's steering is properly performed, without being influenced by the vibration suppression control. Accordingly, the assist control follows the steering torque applied by the driver with excellent responsiveness, thereby providing appropriate steering feeling.

To the contrary, the greater the vibration-suppression gain is, the greater the vibration suppression torque generated by the vibration suppression torque generator 36 is, and therefore the motor torque is greatly corrected so as to suppress the shimmy. In particular, since the vibration suppression torque becomes the peak (a maximum magnitude) at the cut-off angle frequency (=the shimmy occurrence frequency), the motor torque is further greatly corrected.

Further, in a case in which the vibration-suppression gain is outputted with the gain not being advanced, the correction of the motor torque by the adder 33 is executed with the phase not being shifted. Consequently, a so-called rigidity in a control system is applied, so that a vibration having a relatively short cycle is suppressed surely and effectively by this rigidity.

Conversely, in a case in which the vibration-suppression gain is outputted with the gain being advanced (90° advanced, in particular), the correction of the motor torque by the adder 33 is executed with the phase being shifted (90° shifted, in particular). Consequently, a so-called viscosity in the control system is applied, so that a vibration having a relatively long cycle is suppressed surely and effectively by this viscosity (viscosity application control). That is, by variably matching the cur-off angle frequency of the vibration extracting filter 35 with various shimmy occurrence frequencies, there is provided the control device of the electric power steering which is capable of suppressing the tire shimmy. To sum up, in the shimmy occurrence frequency, the viscosity application control to apply the viscosity is performed by outputting the vibration-suppression gain outputted by gain adjuster 35a with the phase being 90° advanced.

Hereafter, an operation of the present embodiment will be described.

The electric power steering control device of the present embodiment comprises the motor 20 to apply the assist torque to the steering device, the torque sensor 10 to detect the steering torque applied by the driver, the assist map 32 to set the motor torque to be outputted to the motor 20 based on the steering torque detected by the torque sensor 10, the motor angle sensor 12 to detect the rotational angle of the motor 20, the filter processor (the vibration extracting filter 35, the gain adjuster 35a) to output the vibration-suppression gain for suppressing the vibration due to the tire rotation by performing the filter processing on the rotational angle of the motor 20 detected by the motor angle sensor 12, and the correcting mechanism (the vibration suppression torque generator 36, the adder 33) to correct the motor torque set by the assist map 32 by using the vibration-suppression gain outputted by the filter processor (35, 35a) so as to suppress the shimmy, wherein the above-described filter processor (35, 35a) includes the vibration extracting filter 35 which has the frequency characteristic that the gain becomes the peak (maximum magnitude) at the cut-off angle frequency ωc and the phase advances by 90° at the cut-off angle frequency ωc and the gain adjustor 35a to vary the cut-off angle frequency ωc of the vibration extracting filter 35 in accordance with the tire rotation frequency which is changeable according to the vehicle speed.

According to the present device, since the cut-off angle frequency ωc of the vibration extracting filter 35 is varied in accordance with the tire rotation frequency which is changeable according to the vehicle speed, even if the shimmy has occurred at any frequency, this vibration is always suppressed by the correction based on the vibration-suppression gain. Accordingly, even if the shimmy occurrence frequency is changeable according to the vehicle's individuality, the aged deterioration of the suspension device 9, or the like, the shimmy is always suppressed properly. Further, since it is unnecessary to previously know the shimmy occurrence frequency, suppressing of the shimmy can be achieved easily. Moreover, since the phase of the vibration-suppression gain is 90° advanced, correcting of the motor torque by the adder 33 is performed with the 90° shifted phase. Consequently, the viscosity is applied (viscosity application control), so that the shimmy is suppressed by the viscosity surely and effectively.

In the present embodiment, there is provided the gain adjuster 35a to adjust the vibration-suppression gain such that the vibration-suppression gain is zero in a range which is lower than the specified lower-limit frequency (6.7 Hz of FIG. 7) which is lower than the shimmy occurrence frequency (7 Hz of FIG. 6) and higher than the frequency of the driver's steering component (about 4-6 Hz) but the vibration-suppression gain becomes greater as the frequency is higher in another range which is higher that the specified lower-limit frequency (6.7 Hz of FIG. 7).

According to this embodiment, since the motor torque set by the assist map 32 is not corrected in the range where the vibration level is low (lower than 6.7 Hz of FIG. 7), the assist control for assisting the driver's steering is properly performed, without being influenced by the vibration suppression control. Meanwhile, since the motor torque set by the assist map 32 is corrected more greatly when the vibration level is higher (higher than 6.7 Hz of FIG. 7), the vibration suppression control is performed properly.

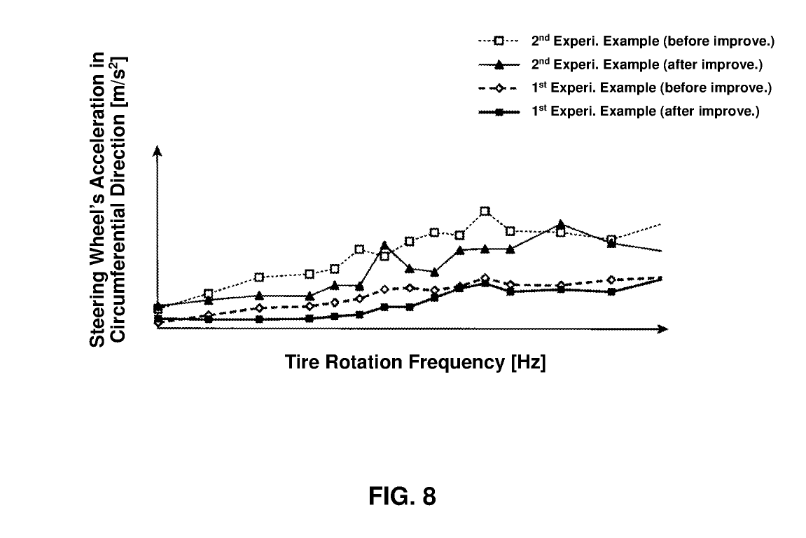

FIG. 8 is experimental data showing that it becomes difficult that the vibration or the shimmy is transmitted to the steering wheel 1 before or after the above-described viscosity application control according to the present embodiment is performed (before or after improvement). A tire weight differs between first and second experimental examples, the tire weight of the first experimental example being lighter than that of the second experimental example. In any case, the vibration level is decreased over a substantially entire range of the tire rotation frequency by performing the viscosity application control of outputting the vibration-suppression gain with the phase being 90° advanced at the shimmy occurrence frequency.

Herein the above-described embodiment shows the example in which the electric power steering is a column assist type, but the present invention is applicable to any type of electric power steering.

Further, while the output of the assist map is the motor torque in the above-described embodiment, the current to be applied to the motor is applicable instead.

Also, the low pass filter 31, the assist map 32, the adder 33, the current controller 34, the vibration extracting filter 35, the gain adjustor 35a, the vibration suppression torque generator 36, and the tire rotation frequency transfer 37 are included in the ECU 30 in the above-described embodiment, but the present invention should not be limited to this, of course.

Further, the above-described manner of correcting the motor torque by the adder 33 and the vibration suppression torque generator 36 is merely an example, and the present invention should not be limited to this, of course.

Moreover, the above-described various magnitudes of the present embodiment are also a merely example, and the present invention should not be limited to these, of course.

Additionally, the above-described viscosity application control is not limited to a case in which the vibration-suppression gain is outputted with the phase being 90° advanced at the shimmy occurrence frequency. For example, even in a case in which the vibration-suppression gain is outputted with the phase being about 90° (including any angle within a specified range close to 90°) advanced at a specified frequency band including the shimmy occurrence frequency (including any frequency within a specified range close to the shimmy occurrence frequency).

What is claimed is:

1. An electric power steering control device, comprising:
a motor to apply an assist torque to a steering device;
a torque detector to detect a steering torque applied by a driver;
a setting mechanism to set a motor torque to be outputted to the motor based on the steering torque detected by the torque detector;
a rotational angle detector to detect a rotational angle of the motor;
a filter processor to output a vibration-suppression gain for suppressing a vibration due to a tire rotation by performing a filter processing on the rotational angle detected by the rotational angle detector; and
a correcting mechanism to correct the motor torque set by the setting mechanism by using the vibration-suppression gain outputted by the filter processor so as to suppress the vibration due to the tire rotation,
wherein said filter processor is configured to include a vibration extracting filter which has a frequency characteristic that a gain becomes a specified magnitude at a cut-off angle frequency and a phase advances by 90° at the cut-off angle frequency and to vary said cut-off angle frequency of the vibration extracting filter in accordance with a tire rotation frequency which is changeable according to a vehicle speed.

2. The electric power steering control device of claim 1, wherein said cut-off angle frequency is varied such that the cut-off angle frequency becomes higher according to an increase of the vehicle speed and the cut-off angle frequency becomes lower according to a decrease of the vehicle speed.

3. The electric power steering control device of claim 1, wherein said cut-off angle frequency is varied stepwise at predetermined intervals.

4. The electric power steering control device of claim 1, wherein said filter processor includes a gain adjuster to adjust said vibration-suppression gain such that the vibration-suppression gain is zero in a range which is lower than a specified lower-limit frequency which is lower than said cut-off angle frequency and higher than a frequency of a driver's steering component but the vibration-suppression gain becomes greater as the frequency is higher in another range which is higher that the specified lower-limit frequency.
